(19) United States
(12) Patent Application Publication
(10) Pub. No.: US 2025/0320896 A1
(43) Pub. Date: Oct. 16, 2025

(54) BEARING DEVICE WITH INTEGRATED ELECTRICAL INSULATION, NOTABLY FOR ELECTRICAL MACHINE OR ELECTRIC MOTOR, AND ASSOCIATED METHODS OF MANUFACTURE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR); Anthony SIMONIN, Tours (FR)

(21) Appl. No.: 19/169,226

(22) Filed: Apr. 3, 2025

(30) Foreign Application Priority Data
Apr. 10, 2024 (FR) 2403688

(51) Int. Cl. F16C 33/04; F16C 33/60; F16C 43/00; H02K 5/173

(52) U.S. Cl. CPC F16C 33/04; F16C 33/60; F16C 43/00; H02K 5/173; F16C 2226/30; F16C 2380/26

(57) ABSTRACT

A bearing device includes a bearing having first and second rings configured for relative rotation, a bushing and an electrically insulating insert overmolded between the second ring and the bushing. The bushing includes a radial groove at least partially aligned with a radial groove in the insulating insert, and the bearing device includes a key having a first portion mounted in the radial groove of the bushing and a second portion mounted in the radial groove of the insulating insert. Also a method of forming the bearing device.

### CROSS-REFERENCE

This application claims priority to French patent application no. 2403688 filed on Apr. 10, 2024, the contents of which are fully incorporated herein by reference.

### TECHNOLOGICAL FIELD

The present disclosure is directed to the field of bearings used in particular in electric motors, electrical machines and associated equipment.

### BACKGROUND

In an electric motor or an electrical machine, at least one rolling bearing is mounted between the casing of the electric motor or the electrical machine and the rotary shaft in order to support that shaft. In operation, when the shaft is rotating, an electrical potential difference can appear between the latter and the casing of the electric motor or the electrical machine, which generates an electrical current between the inner ring of the rolling bearing that is locked onto the shaft and the outer ring that is locked onto the casing. The electric current passing through the components of the rolling bearing can damage the components, notably the rolling elements and the raceways on the inner and outer rings. Electrical discharges can also generate vibrations.

To remedy these drawbacks it is known to replace the rolling elements of the bearing made of the same steel as the inner and outer rings by ceramic rolling elements. This bearing is then generally referred as a hybrid rolling bearing. However, such a hybrid rolling bearing is relatively costly.

To remedy the aforementioned drawbacks it is also known to equip the outer ring of the rolling bearing with an insulating sleeve provided with a bushing and an insulating insert made of electrically insulative material disposed radially between the outer ring and the bushing. It is possible to overmold the insulating insert in order to fix the insulating insert to the outer ring and to the bushing with no additional component or particular machining of the outer ring. However, with such a solution there can in operation occur relative separation of the insulating insert and the bushing.

### SUMMARY

An aspect of the present disclosure to remedy the aforementioned drawbacks by providing a bearing device of simple and economical design. The bearing device includes a first ring and a second ring configured to rotate relative to one another. The bearing device further comprises at least one insulating sleeve mounted on the second ring of the bearing. The insulating sleeve includes a bushing and an insulating insert disposed radially between the second ring and the bushing. The insulating insert is made of electrically insulative material.

The bushing comprises an exterior surface and an interior surface opposite the exterior surface that delimit the radial thickness of the bushing. The insulating insert is overmolded onto the second ring of the bearing and at least onto the exterior and/or interior surface(s) of the bushing. In accordance with one general feature at least one first groove is formed on the bushing. In accordance with another general feature at least one first groove is formed on the insulating insert. This first groove of the insulating insert is situated at least in part in radial alignment with the first groove of the bushing.

In accordance with another general feature the device further comprises at least one first key housed at least in part in the first grooves of the bushing and the insulating insert. By “key housed at least in part in the groove” is meant a key that is housed directly in the groove or indirectly in the groove with an intermediate element between them, for example a part of the insulating insert.

There is thus obtained a bearing device with integrated electrical insulation that is economical compared to conventional hybrid rolling bearings. Furthermore, the device is easy to manufacture and to assemble in the electric motor or the associated electrical machine. Furthermore, the provision of the first key enables the bushing and the insulating insert to be locked together in the circumferential direction. The risk of relative movement between the insulating insert and the bushing in the circumferential direction is notably prevented in the event of temperature variations.

By “circumferential direction” is meant the direction that is perpendicular both to the axial direction and to a radius of the bearing device, in other words tangential to a circle the center of which is on the axis of the bearing device. By “axial direction” is meant the direction that is parallel to the axis of the bearing device. By “key” is meant an element for locking together the bushing and the insulating insert that may have any shape in cross section, for example a polygonal shape such as a square or rectangular shape, or a circular, oval, half-moon, etc. shape.

The first key can be made of an electrically-insulative material. Alternatively, the first key can be made of an electrically conductive material if it is surrounded at one end at least by an electrically insulating material.

In one particular design at least one first groove can be formed on the second ring and situated radially in line with the first groove of the insulating insert. In this case the first key can advantageously be housed at least in part in the first groove of the second ring. The bushing, the insulating insert and the second ring of the bearing are therefore locked together in the circumferential direction. The first groove on the second ring can open onto one of the front faces of the latter.

The bushing can also comprise two opposite radial front faces that delimit the axial length of the bushing. The insulating insert can comprise two opposite radial front faces that delimit the axial length of the insert. The first groove of the bushing can be formed on one of the front faces of the latter. The first groove of the insulating insert can be formed on one of the front faces of the latter. The first key can be flush with or remain set back relative to the front face of the bushing and the front face of the insulating insert.

Alternatively the first key can project axially relative to the front face of the bushing and the front face of the insulating insert. In this case the first key can extend in a groove formed in the casing in which the bearing device is mounted. The first key forms a means for preventing rotation of the device relative to the casing.

The first key preferably comprises two opposite front faces that delimit the circumferential dimension of the first key. The front faces of the first key can be planar.

In one particular design the device further comprises at least one second key housed at least in part in the second groove of the bushing and the insulating insert. The second groove in the insulating insert is situated at least in part radially in line with the second groove in the bushing. The second key can be diametrically opposite the first key. The second key can be made of electrically insulative material. Alternatively, the second key can be made of electrically conductive material if it is surrounded at one end at least by an electrically insulative material.

In other designs the device can comprise only the first key or at least three keys preferably spaced from one another in the circumferential direction.

Making the insulating insert of synthetic material or elastic material makes it possible to render the device relatively insensitive to temperature variations.

In one particular embodiment the bushing is made of metal. The bushing can therefore be easily machined to a predetermined radial tolerance.

In one embodiment the insulating insert covers the whole of the surface of the bushing. In this case the insulating insert entirely covers the surface of the bushing in the axial direction and in the circumferential direction.

In a first design the bushing delimits the exterior surface of the device. In this case the second ring is the outer ring of the bearing. In an alternative second design the bushing delimits the interior surface of the device. In this case the second ring is the inner face of the bearing.

In one particular embodiment the bearing comprises at least one row of rolling elements disposed between raceways of the first and second rings. The rolling elements can be made of metal.

The disclosure also includes a bearing device comprising a bearing including a first ring and a second ring configured to rotate relative to each other, the second ring having a first cylindrical surface and a second cylindrical surface radially spaced from the first cylindrical surface. The bearing device also includes a bushing having an axial length and a first cylindrical surface and a second cylindrical surface radially spaced from the first cylindrical surface of the bushing and an electrically insulating insert overmolded between and connecting the first cylindrical surface of the bushing and the second cylindrical surface of the second ring. The bushing includes a radial groove at least partially aligned with a radial groove in the insulating insert, and the bearing device includes a key having a first portion mounted in the radial groove of the bushing and a second portion mounted in the radial groove of the insulating insert.

The disclosure is also directed to an electric motor comprising a casing, a shaft and at least one bearing device as defined above mounted radially between the casing and the shaft.

The disclosure is also directed to a method of manufacturing a bearing device as defined above comprising the following successive steps: mounting the bushing and at least the second ring in a mold, overmolding the insulating insert onto the second ring and at least onto the surface of the bushing, and mounting the first key in the first grooves of the insulating insert and the bushing.

The method can further comprise, after overmolding the insulating insert and before mounting the first key, machining at least the first groove in the insulating insert. Alternatively, at least the first groove could be obtained directly in the mold.

The disclosure is also directed to a method of manufacturing a bearing device as defined above comprising the following successive steps: machining at least the first groove of the bushing, mounting the first key in the first groove of the bushing, mounting the bushing equipped with the first key and at least the second ring in a mold, and overmolding the insulating insert onto the second ring and at least onto the surface of the bushing.

The disclosure is also directed to a method of manufacturing a bearing device as defined above comprising the following successive steps: machining at least the first groove of the second ring, mounting the first key in the first groove of the second ring, mounting the bushing and at least the second ring equipped with the first key in a mold, and overmolding the insulating insert onto the second ring, at least onto the surface of the bushing and onto the first key.

### BRIEF DESCRIPTION OF THE DRAWINGS

The present disclosure will be better understood after studying the detailed description of embodiments provided by way of non-limiting example and depicted in the appended drawings, in which:

FIG. 1 is an axial sectional view of a portion of a bearing device according to a first embodiment of the disclosure.

FIG. 2 is a perspective view of the bearing device of FIG. 1.

FIG. 3 is a detail view of a portion of FIG. 2.

FIG. 4 is a flowchart depicting the method of manufacturing the bearing device of FIG. 1.

FIG. 5 is an axial sectional view of a portion of a bearing device according to a second embodiment of the disclosure.

FIG. 6 is a perspective view of the bearing device of FIG. 5

FIG. 7 is an axial sectional view of a portion of a bearing device according to a third embodiment of the disclosure.

FIG. 8 is a perspective view of the bearing device from FIG. 7.

FIG. 9 is a detail view of a portion of FIG. 8.

FIG. 10 is an exploded perspective view of a portion the bearing device of FIG. 7.

FIG. 11 is a flowchart depicting the method of manufacturing the bearing device of FIG. 7.

FIG. 12 is an axial sectional view of a portion of a bearing device according to a fourth embodiment of the disclosure.

FIG. 13 is a perspective view of the bearing device of FIG. 12.

FIG. 14 is a detail view of a portion of FIG. 13.

FIG. 15 is an exploded perspective view of a portion the bearing device of FIG. 12.

FIG. 16 is a flowchart depicting the method of manufacturing the bearing device of FIG. 12.

### DETAILED DESCRIPTION

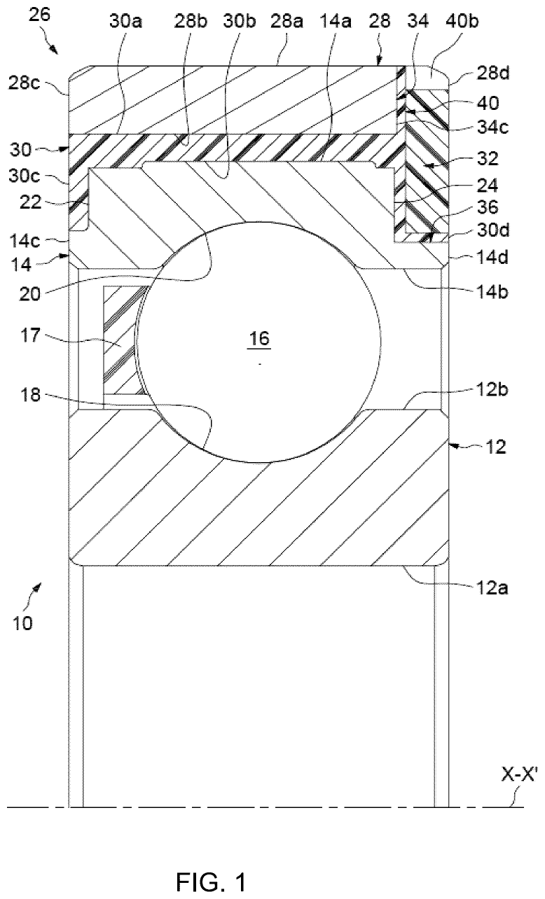

The bearing device depicted in FIG. 1 comprises a bearing 10 including a first ring 12 and a second ring 14 that are configured to rotate relative to one another about the axis X-X′ of the bearing. In the embodiment depicted the first ring 12 is the inner ring of the bearing and the second ring 14 is the outer ring.

The bearing device is designed so as not to conduct electrical currents. The bearing device incorporates integrated electrical insulation.

The inner ring 12 and the outer ring 14 of the bearing are concentric and extend axially along the axis X-X′ of the bearing. The inner ring 12 and the outer ring 14 are made of steel. The rings are of the solid type.

In the embodiment depicted the bearing 10 also comprises a row of rolling elements 16, here balls, disposed radially between the inner ring 12 and the outer ring 14. The rolling elements 16 are made of steel. The bearing 10 also comprises a cage 17 to maintain the regular circumferential spacing of the rolling elements 16. The bearing 10 can be further equipped with seals or sealing flanges.

The inner ring 12 comprises a cylindrical bore 12a, a cylindrical axial outer surface 12b radially opposite the bore, and two opposite radial front faces (no reference number) axially delimiting the bore and the exterior surface. The bore 12a and the exterior surface 12b delimit the radial thickness of the inner ring 12. The bore 12a forms the interior surface of the inner ring. The inner ring 12 further comprises an inner raceway 18 for the rolling elements 16 that is formed on the exterior surface 12b. The raceway 18 is directed radially outward.

The outer ring 14 comprises a cylindrical axial exterior surface 14a, a cylindrical bore 14b radially opposite the exterior surface 14a, and two opposite radial front faces 14c, 14d axially delimiting the bore. The exterior surface 14a and the bore 14b delimit the radial thickness of the outer ring 14. In the embodiment depicted the exterior surface 14a of the ring has two distinct diameters. Alternatively, the exterior surface 14a could have only one diameter. The outer ring 14 further comprises an outer raceway 20 for the rolling elements 16 that is formed in the bore 14b. The raceway 20 is directed radially inward.

In the embodiment depicted a groove 22 is formed on the front face 14c of the outer ring. The groove 22 is oriented and axially open to the exterior of the outer ring. The groove 22 has a bottom that faces axially and is offset axially toward the interior of the ring relative to the front face 14c. The bottom of the groove 22 forms a shoulder. Here the bottom of the groove 22 extends radially to simplify manufacture. Here the groove 22 is annular.

Similarly, a groove 24 is formed on the front face 14d of the outer ring. The groove 24 is oriented and axially open to the exterior of the outer ring. The groove 24 has a bottom that is offset axially toward the interior of the ring relative to the front face 14d. The bottom of the groove 24 forms a shoulder. Here the bottom of the groove 24 extends radially. Here the groove 24 is annular. The grooves 22, 24 are symmetrical to one another relative to a median radial plane of the outer ring. The grooves 22, 24 axially delimit the exterior surface 14a.

The bearing device also comprises an electrical insulation sleeve 26 mounted on the outer ring 14. The insulation sleeve 26 is mounted on the exterior surface 14a of the outer ring 14. The insulating sleeve 26 is locked onto the outer ring 14.

The insulating sleeve 26 comprises a bushing 28 and an insulating insert 30 disposed radially between the outer ring 14 and the bushing 28. The insulating insert 30 is overmolded on the outer ring 14 and the bushing 28.

As described in more detail hereinafter, the bearing device also comprises first and second keys 32, 33 to constrain the bushing 28 and the insulating insert 30 to rotate together, that is, to rotationally lock the insulating insert 30 to the bushing 28.

The bushing 28 is annular and extends axially. Here the bushing 28 is produced in one piece. Alternatively, the bushing 28 could be made in the form of a plurality of parts pressed together, for example two identical parts. The bushing 28 has a cylindrical annular axial exterior surface 28a and an annular bore 28b radially opposite the exterior surface 24a. The bore 28b forms the interior surface of the bushing 24. The bore 28b is oriented radially inward, i.e. on the side of the outer ring 14.

The bushing 28 also has two opposite radial front faces 28c, 28d axially delimiting the bore and the exterior surface. The front faces 28c, 28d delimit the axial length of the bushing. The exterior surface 28a and the bore 28b delimit the radial thickness of the bushing 24. The exterior surface 28a of the bushing delimits the exterior surface of the bearing device 10. In other words, the exterior surface 28a defines the outside diameter of the bearing device 10.

In the embodiment depicted the front faces 28c, 28d of the bushing are respectively coplanar with the front faces 14c, 14d of the outer ring. Alternatively, it would be possible to provide other arrangements. For example, the bushing 28 could have a lesser or greater axial dimension and remain axially set back from the faces 14c, 14d of the outer ring or project from the faces.

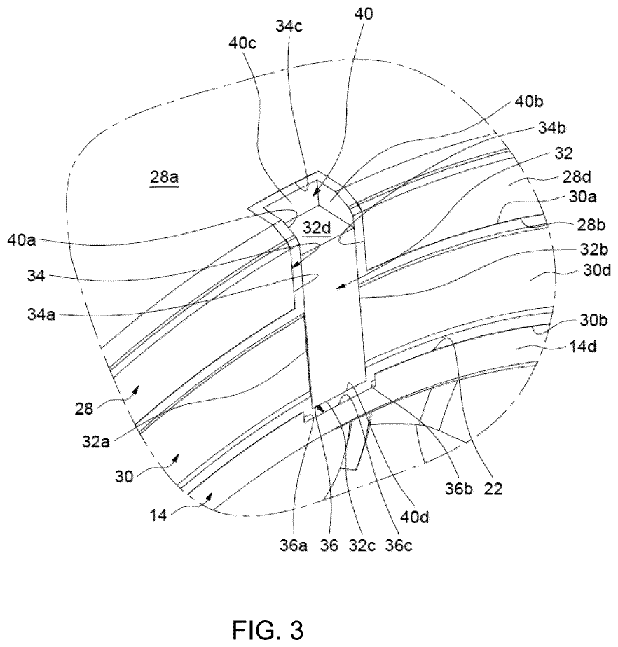

Referring to FIG. 3, a first groove 34 is formed on the bushing. The first groove 34 is formed on the front face 28d of the bushing. The groove 34 is oriented and open axially outward. The groove 34 opens radially into the bore 28b of the bushing. In the embodiment depicted the groove 34 also opens radially onto the exterior surface 28a of the bushing.

The groove 34 is delimited in the circumferential direction by two insert lateral flanks 34a, 34b that are connected to one another by a radial bottom 34c. Here the flanks 34a, 34b are rectilinear and extend radially. The bottom 34c also extends radially and is oriented axially outward. Alternatively, the groove 34 could have no bottom, the flanks 34a, 34b then being connected directly.

In the embodiment depicted a first groove 36 is formed on the outer ring. The groove 36 is formed on the exterior surface of the groove 22 on the outer ring and opens onto the front face 14d. The groove 36 is open axially outward. The groove 36 is oriented and open radially outward.

The groove 36 is delimited in the circumferential direction by two insert lateral flanks 36a, 36b that are connected to one another by a radial bottom (not visible). The groove 36 also comprises an axial bottom 36c that is connected to the flanks 36a, 36b and to the radial bottom. Here the flanks 36a, 36b are rectilinear and extend radially. The radial bottom also extends radially and is oriented axially outward. Alternatively, the groove 36 could have no bottom, the flanks 36a, 36b then being connected directly.

The insulating insert 30 is made of electrically insulative material. The insulating insert 30 can for example be made of synthetic material, such as PEEK or PA46, or elastomer material, for example rubber.

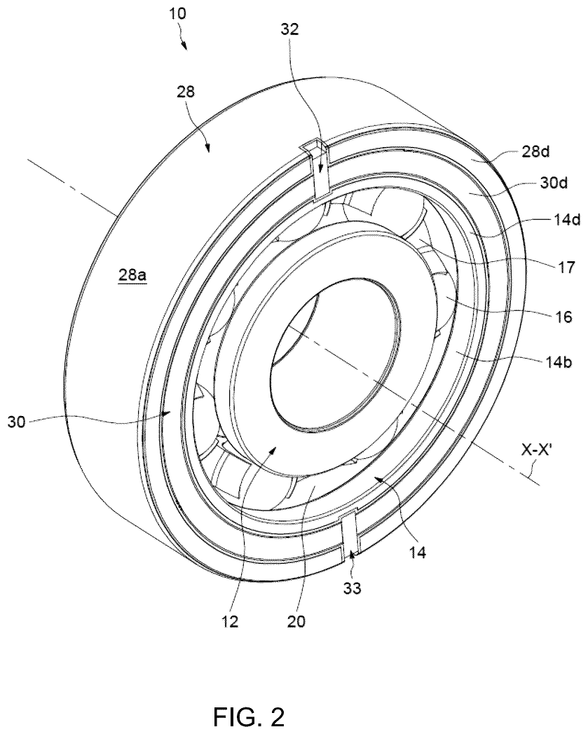

Referring to FIGS. 1 to 3, the insulating insert 30 is disposed radially between the exterior surface 14a of the outer ring and the bore 28b of the bushing. The insulating insert 30 covers the exterior surface 14a of the outer ring. Here the insulating insert 30 covers the exterior surface 14a entirely in the axial and circumferential directions. The insulating insert 30 also covers the grooves 22, 24 of the outer ring. The insulating insert 30 also covers the groove 36 of the outer ring. The insulating insert 30 covers the flanks 36a, 36b and the axial bottom 36c and the radial bottom of the groove 36.

The insulating insert 30 also covers the bore 28b of the bushing. Here the insulating insert 30 also covers entirely the bore 28b in the axial and circumferential directions. The insulating insert 30 also covers the groove 34 of the bushing. The insulating insert 30 covers the flanks 34a, 34b and the bottom 34c of the groove.

The insulating insert 30 is annular and extends axially. The insulating insert 30 comprises a cylindrical axial exterior surface 30a, a cylindrical bore 30b radially opposite the exterior surface 30a, and two opposite radial front faces 30c, 30d axially delimiting the bore and the exterior surface. The radial front faces 30c, 30d delimit the axial length of the insulating insert 30. The exterior surface 30a is in radial contact with the bore 28b of the bushing. The part of the insulating insert 30 that covers the groove 34 forms a protuberance that extends radially outward. The bore 30b is in radial contact with the exterior surface 14a of the outer ring, with the grooves 22, 24 and with the axial bottom 38c of the groove 38. The bore 30b has a stepped shape. The part of the insulating insert 30 that covers the groove 36 forms a protuberance that extends radially inward.

In the embodiment depicted the respective faces 14c, 30c, 28c and 14d, 30d, 28d of the outer ring, of the insulating insert and of the bushing are coplanar. Alternatively, it is possible to use other arrangements. For example, the insulating insert 30 could have a smaller axial dimension and remain axially set back from the faces 14c, 14d of the outer ring. Alternatively, the insulating insert 30 could have an increased axial dimension and project radially from the faces 14c, 14d of the outer ring. In this case, the insulating insert 30 can cover these faces 14c, 14d at least in part. Alternatively, the insulating insert 30 could cover the faces 28c, 28d of the bushing at least in part.

Alternatively or in combination the bushing 28 could project axially from the insulating insert 30 relative to the faces 30c and 30d or remain axially set back from the faces.

The insulating insert 30 also comprises a first groove 40 that is formed in the part of the insert that covers the groove 24 of the bushing and forms the exterior protuberance. This groove 40 extends within the radial thickness of the insert. The groove 40 extends radially inward to the vicinity of the exterior surface 30b of the outer ring. The groove 40 is radially open on the exterior side. The groove 36 is situated radially in line with the groove 40. The groove 40 is oriented and open axially outward. The groove 40 opens onto the front face 30d of the insulating insert.

The groove 40 is delimited in the circumferential direction by two insert lateral flanks 40a, 40b that are connected to one another by a radial bottom 40c. Here the flanks 40a, 40b are rectilinear and extend radially. The bottom 40c also extends radially and is oriented axially outward. Alternatively, the groove 40 could have no bottom, the flanks 40a, 40b then being connected directly. The groove 40 also comprises an axial bottom 40d that is connected to the flanks 40a, 40b and to the radial bottom 40c.

As indicated above, the bearing device includes the first key 32. The key 32 is mounted in the groove 40 of the insulating insert. The key 32 is mounted indirectly in the groove 34 of the bushing with part of the insulating insert delimiting the groove 40 between the key and the groove.

The key 32 comes to bear in the circumferential direction against the flanks 40b, 40c of the groove 40 of the insulating insert. The key 32 bears axially against the bottom 40c of the groove. The key 32 has two lateral faces 32a, 32b that respectively come to bear in the circumferential direction against the flanks 40b, 40c. The faces 32a, 32b delimit the circumferential dimension of the key 32. Here the key 32 is a key of the parallel type. Alternatively, the key 32 could have other shapes, and for example the faces 32a, 32b could be not parallel and notably of the dovetail type or have a stepped profile. The key 32 could further have a cylindrical or other shape.

The key 32 also has an interior face 32c bearing radially against the axial bottom 40c of the groove and an opposite exterior face 32d. The faces 32c, 32d delimit the radial height of the key 32. Here the exterior face 32d is radially set back from the exterior surface 28a of the outer ring. Alternatively, the exterior face 32d of the key could be flush with the exterior surface 28a.

The key 32 could be fixed in the groove 40 by any appropriate means, for example by a force fit, by gluing, by adhesive bonding, by overmolding, by dual injection molding, etc. Alternatively, the key 32 can be mounted freely in the groove 40.

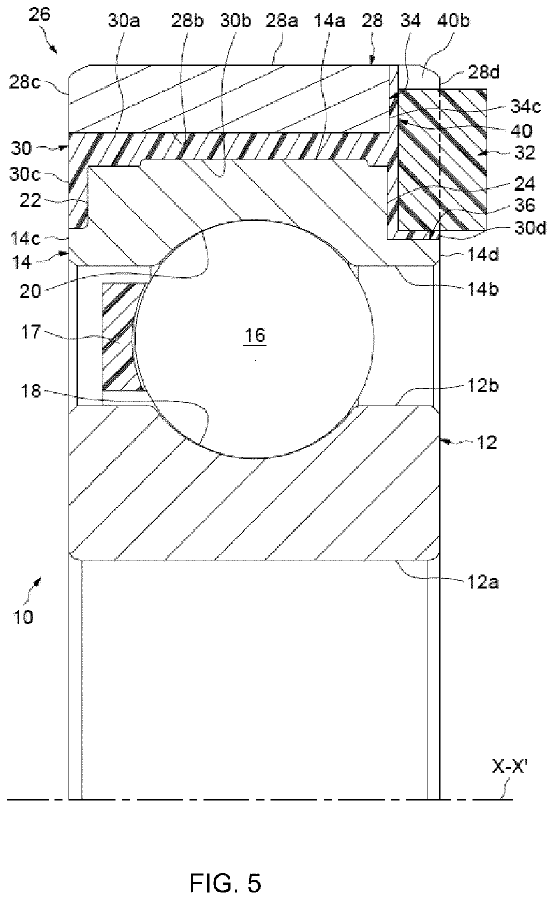

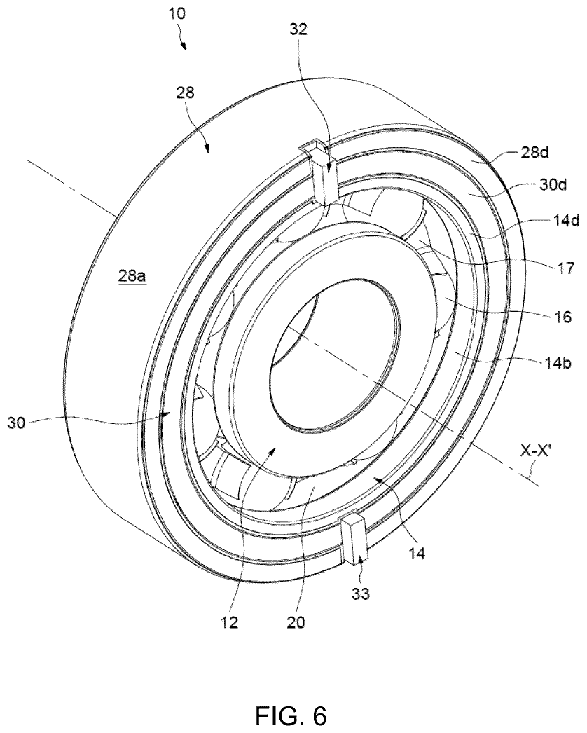

In the embodiment depicted the key 32 is flush with the front face 28d of the bushing and the front face 30d of the insulating insert. Alternatively, the key 32 could remain set back relative to the front faces 38d, 30d of the bushing and the insulating insert or project axially relative to the faces as depicted in the embodiment from FIGS. 5 and 6.

As indicated above the bearing device also comprises the second key 33. The second key 33 is identical to and diametrically opposite the first key 32. The key 33 is mounted on the bushing 28 and the insulating insert 30 in exactly the same way as the first key 32 and this will not be described in more detail.

Here the first and second keys 32, 33 are made of electrically insulative material. The keys 32, 33 can for example be made of synthetic material, such as PEEK or PA46, or be made of elastomer material, for example rubber. Alternatively, the first and second keys 32, 33 could be made of electrically conductive material and surrounded at one end at least with an electrically insulative material.

The bearing device is manufactured in the following manner.

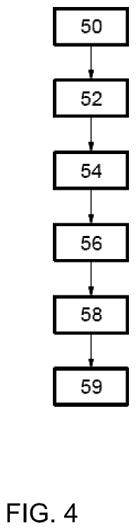

In a first step 50 depicted in FIG. 4 the groove 34 and the groove (no reference number) diametrically opposite the bushing 28 are machined. The groove 36 and the groove (no reference number) diametrically opposite the outer ring 14 are also machined.

In a successive second step 52 the bearing 10 and the bushing 28 are mounted in a mold for overmolding the insulating insert 30. In this position mounted in the mold the bushing 28 is radially at a distance from the outer ring 14 of the bearing.

In a successive third step 54 the insulating insert 30 is overmolded both onto the outer ring 14 of the bearing and onto the bushing 28.

Then, in a fourth step 56 the unitary assembly formed by the bearing 10, the bushing 28 and the insulating insert 30 is extracted from the mold.

Then, in a successive fifth step 58 the groove 40 and the groove (no reference number) diametrically opposite the insulating insert are machined. Alternatively, the grooves could be produced directly in the mold.

Finally, in a sixth step 59 the first and second keys 32, 33 are mounted in the grooves of the insulating insert.

The first and second keys 32, 33 are inserted axially in the grooves of the insulating insert. Alternatively, the first and second keys 32, 33 could be inserted radially in the grooves of the insulating insert, for example if the grooves do not open axially on the side of the device.

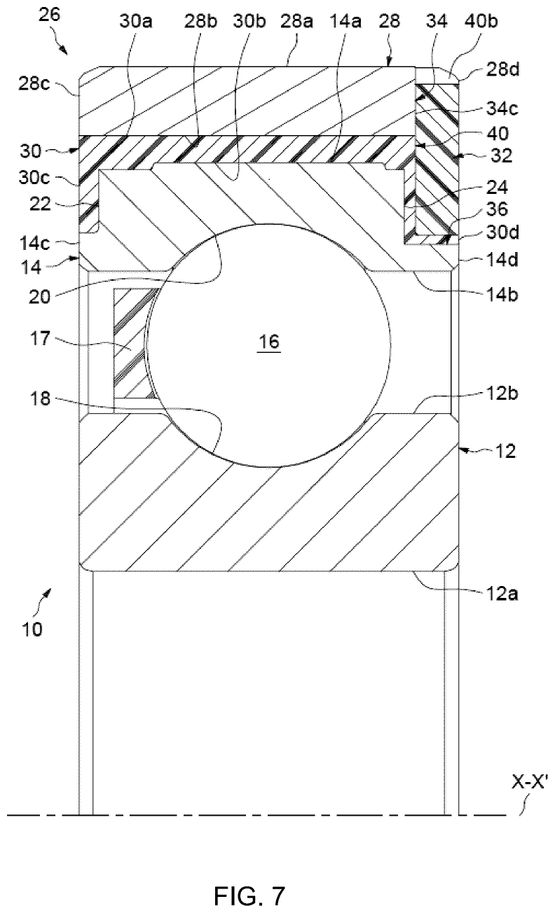

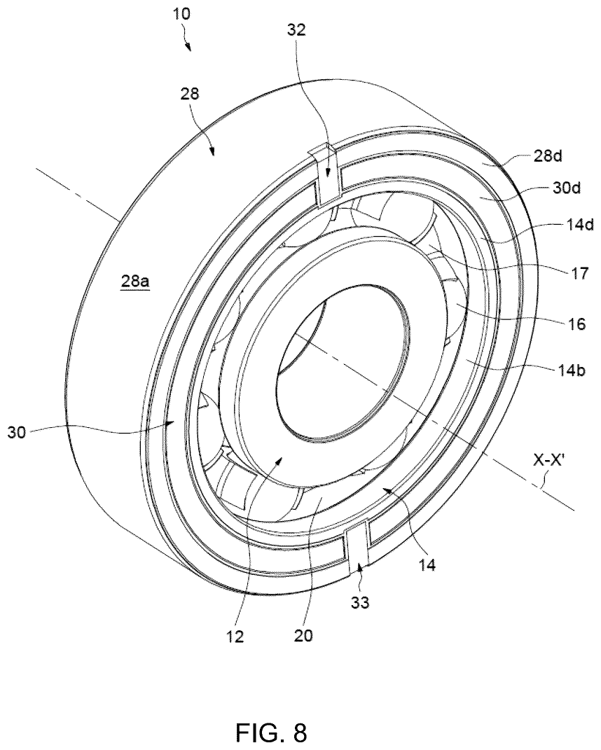

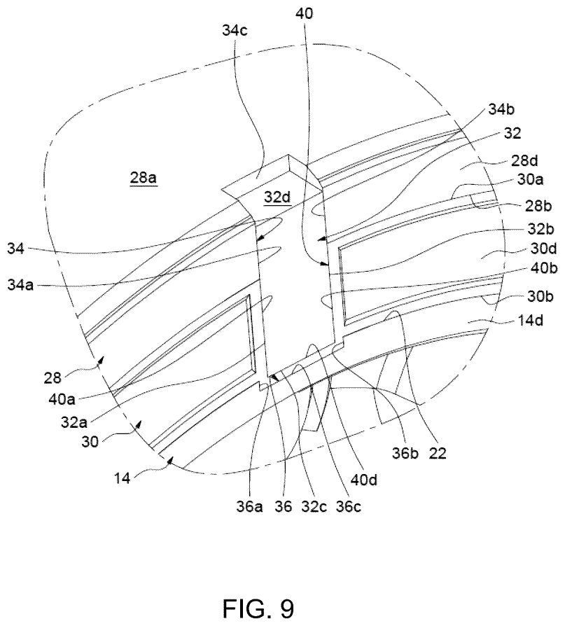

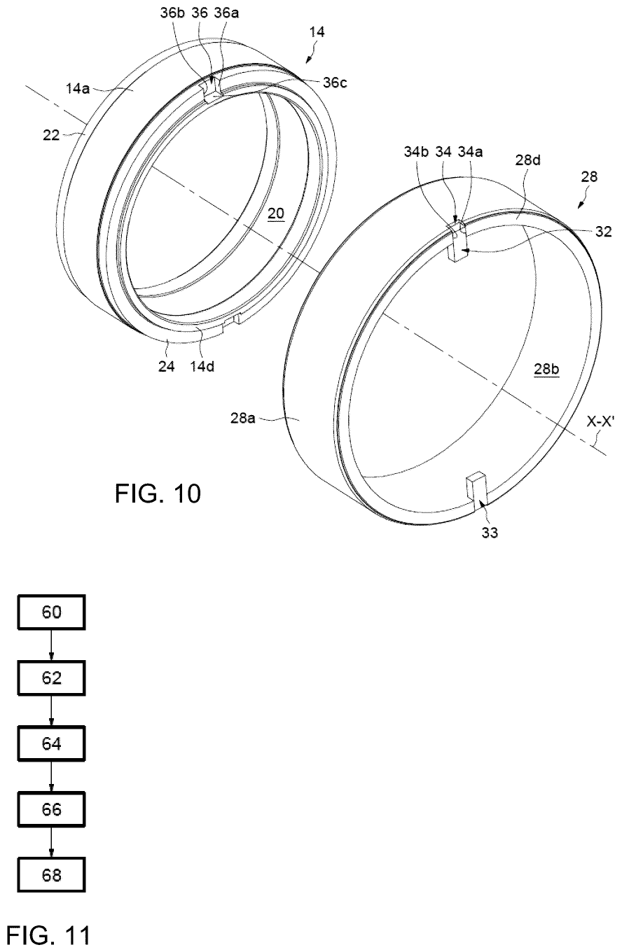

The embodiment depicted in FIGS. 7 to 10, in which identical elements bear the same reference numbers, differs mainly from the first embodiment in that the key 32 is mounted directly in the groove 34 of the bushing. Thus in this example the key 32 is mounted directly in the groove 34 of the bushing and directly in the groove 40 of the insulating insert. The key 32 is mounted to bear axially against the bottoms of the grooves 34, 40.

In this embodiment, the radial dimension of the groove 40 of the insulating insert 30 is reduced. The groove 40 is situated radially in line with the groove 34. The flanks 40a, 40b of the groove 40 respectively extend radially inward the flanks 34a, 34b of the groove 34. The key 32 comes to bear in the circumferential direction against the flanks 34a, 34b of the groove 34 and the flanks 40b, 40c of the groove 40.

As in the first embodiment the key 33 is mounted in exactly the same way as the first key 32.

The bearing device is manufactured in the following manner.

In a first step 60 depicted in FIG. 11 the groove 34 and the groove (no reference number) diametrically opposite the bushing 28, which are provided for mounting the first and second keys 32 and 33, are machined. The groove 36 and the groove (no reference number) diametrically opposite the outer ring 14 are also machined.

In a successive second step 62 the keys 32, 33 are mounted in the grooves of the bushing 28. The bushing 28 therefore supports the keys 32, 33.

Then, in a third step 64 the bearing 10 and the bushing 28 are mounted in the mold for overmolding the insulating insert 30. In this position mounted in the mold the bushing 28 and the keys 32, 33 are radially at a distance from the outer ring 14 of the bearing.

Then, in a successive fourth step 66 the insulating insert 30 is overmolded onto the outer ring 14 of the bearing, the bushing 28 and the keys 32, 33.

Finally, in a fifth step 68 the bearing device, which takes the form of a unitary assembly, is extracted from the mold.

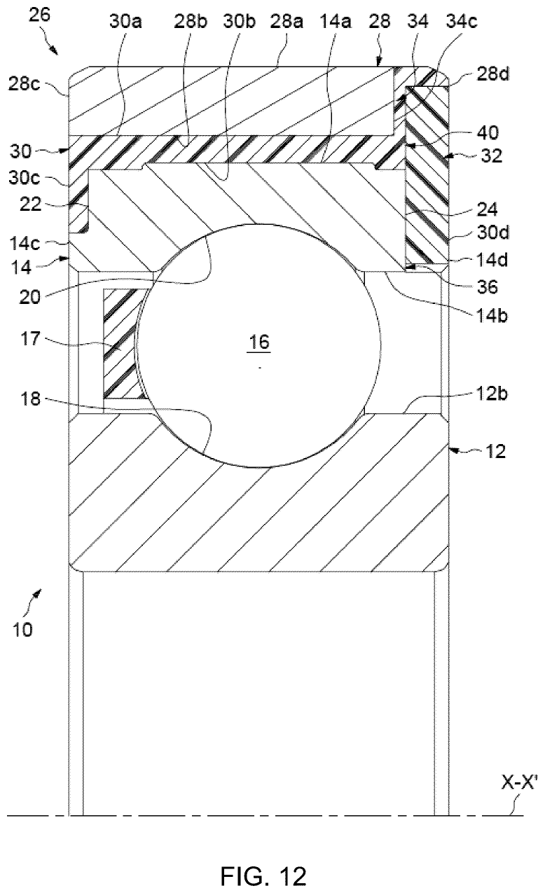

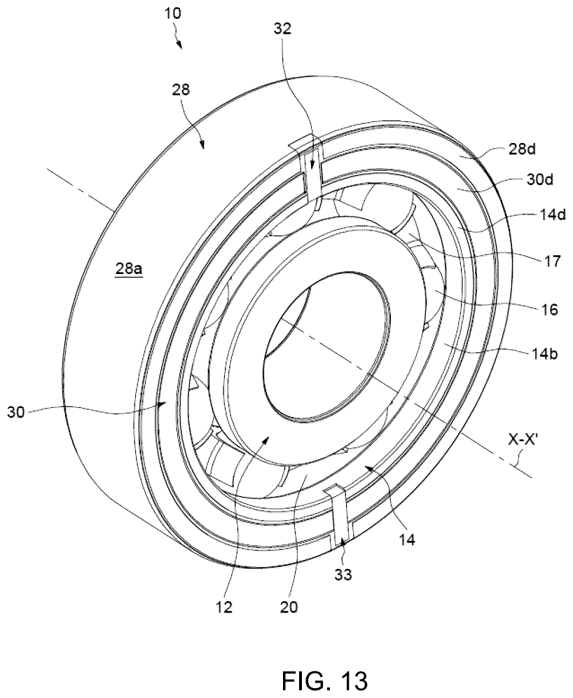

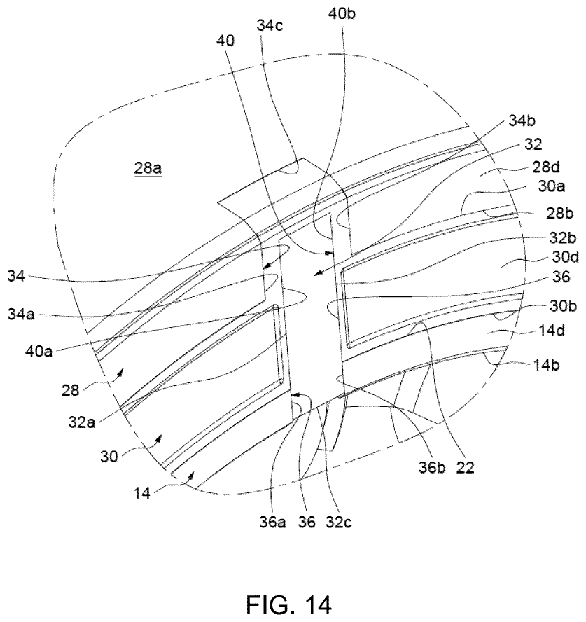

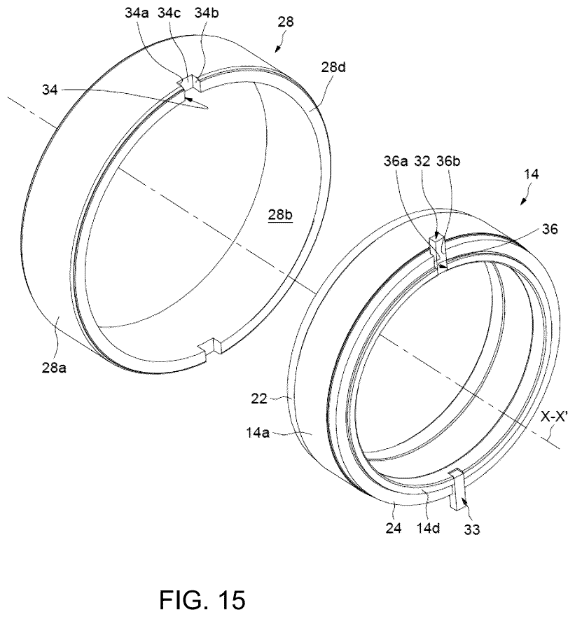

The embodiment depicted in FIGS. 11 to 14, in which identical elements bear the same reference numbers, differs from the first embodiment mainly in that the key 32 is mounted in the groove 36 of the outer ring.

In this embodiment the groove 36 is radially in line with the groove 40. The flanks 36a, 36b of the groove 36 extend radially inward the respective flanks 40a, 40b of the groove 40. The groove 36 opens radially into the bore 14b of the outer ring. The key 32 comes to bear in the circumferential direction against the flanks 36a, 36b of the groove 36 and the flanks 40b, 40c of the groove 40. The key 32 is mounted so as to bear axially against the bottoms of the grooves 36, 40.

In this embodiment the insulating insert 30 covers the upper face of the key 32. The insulating insert 30 also covers the whole of the groove 40 and is flush with the exterior surface 28 of the bushing. As in the first embodiment the key 33 is mounted in exactly the same way as the first key 32.

The bearing device is manufactured in the following manner.

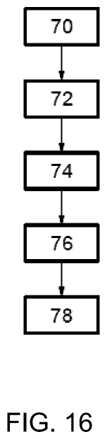

In a first step 70 depicted in FIG. 16 the groove 36 and the groove (no reference number) diametrically opposite the outer ring 14, which are for mounting the first and second keys 32 and 33, are machined. The groove 34 and the groove (no reference number) diametrically opposite the bushing are also machined.

In a successive second step 72 the keys 32, 33 are mounted in the grooves of the outer ring 14. The outer ring 14 therefore supports the keys 32, 33 at this stage.

Then, in a third step 74 the bearing 10 and the bushing 28 are mounted in the mold for overmolding the insulating insert 30. In this position mounted in the mold the bushing 28 is radially at a distance from the outer ring 14 of the bearing.

Then, in a successive fourth step 76 the insulating insert 30 is overmolded onto the outer ring 14 of the bearing, onto the bushing 28 and onto the keys 32, 33.

Finally, in a fifth step 78 the bearing device, which takes the form of a unitary assembly, is extracted from the mold.

In the embodiments depicted the first ring 12 of the bearing is the inner ring and the second ring 14 onto which the insulating insert 30 is overmolded is the outer ring.

Alternatively, it is possible to employ an opposite arrangement in which the second ring 14 onto which the insulating insert 30 is overmolded is the inner ring. In this case the insulating insert is situated in the bore 12a of the inner ring. The insulating insert is then disposed radially between the bore 12a of the inner ring and the exterior surface of the bushing. The insulating insert is overmolded onto the inner ring and at least onto the exterior surface of the bushing. The bore of the bushing delimits the bore of the bearing device.

In the embodiments described the bearing of the device has only one row of rolling elements. The bearing can alternatively include a plurality of rows of rolling elements. Furthermore, the rolling bearing can comprise types of rolling elements other than balls, for example rollers. In another variant the bearing can be a sliding bearing with no rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearing device.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing,
an electrically insulating insert overmolded between and connecting the first cylindrical surface of the bushing and the second cylindrical surface of the second ring, and
a key,
wherein the bushing includes a radial groove at least partially aligned with a radial groove in the insulating insert, and
wherein a first portion of the key is mounted in the radial groove of the bushing and a second portion of the key is mounted in the radial groove of the insulating insert.

2. The bearing device according to claim 1,
wherein the second ring includes a groove at least partially aligned with the groove of the insulating insert, and
wherein a third portion of the key is mounted in the groove of the second ring.

3. The bearing device according to claim 2,
wherein the second ring includes a first radial face axially spaced from a second radial face, and
wherein the groove of the second ring extends into the first radial face of the second ring.

4. The bearing device according to claim 3,
wherein the groove of the bushing extends from the first cylindrical surface of the bushing to the second cylindrical surface of the bushing.

5. The bearing device according to claim 1,
wherein the bushing includes a first radial face axially spaced from a second radial face,
wherein the insulating insert includes a first radial face axially spaced from a second radial face,
wherein the groove of the bushing extends into the first radial face of the bushing, and
wherein the groove of the insulating insert extends into the first radial face of the insulating insert.

6. The bearing device according to claim 5,
wherein the second ring includes a first radial face axially spaced from a second radial face, and
wherein the groove of the second ring extends into the first radial face of the second ring.

7. The bearing device according to claim 6,
wherein a radial side of the key is flush with the first radial face of the bushing and flush with the first radial face of the insulating insert.

8. The bearing device according to claim 6,
wherein a radial side of the key is axially spaced from the first radial face of the bushing and axially spaced from the first radial face of the insulating insert.

9. The bearing device according to claim 6,
wherein a first portion of the insulating insert extends into the groove of the bushing and a second portion of the insulating insert extends into the groove of the second ring.

10. The bearing device according to claim 1,
wherein a first portion of the insulating insert extends into the groove of the bushing.

11. The bearing device according to claim 1,
wherein the groove of the bushing includes at least two radially extending walls, and
wherein a first portion of the insulating insert covers the at least two radially extending walls of the groove of the bushing.

12. An electric motor comprising:
a casing,
a shaft, and
at least one bearing device according to claim 1 mounted radially between the casing and the shaft.

13. A method comprising:
mounting a bushing having a radial groove in an axially facing surface and a bearing ring in a mold,
overmolding an electrically insulating insert between the bushing and the bearing ring to connect the bushing to the bearing ring such that the electrically insulating insert does not completely fill the groove of the bushing and such that the electrically insulating insert has a groove at least partially aligned with the groove of the bushing and
after the overmolding, inserting a key into the groove of the bushing and into the groove of the insulating insert.

14. The method according to claim 12,
wherein the bearing ring includes a radial groove in an axially facing surface of the bearing ring,
wherein the bearing ring is mounted in the mold with the radial groove of the bearing ring at least partially aligned with the groove of the insulating insert, and
wherein inserting the key comprises inserting a portion of the key into the groove of the bearing ring.

15. A method comprising,
mounting a bushing having a radial groove in an axially facing surface and a bearing ring in a mold,
inserting a key in the radial groove such that a first portion of the key extends radially from the radial groove,
overmolding an electrically insulating insert between the bushing and the bearing ring to secure the key to the bushing and the bearing ring and to secure the bushing and the bearing ring to one another.

16. The method according to claim 15,
wherein the bearing ring includes a radial groove,
wherein inserting the key comprises inserting the key such that a first portion of the key is located in the groove of the bushing and a second portion of the key is located in the groove of the second ring.
